(19) United States
(12) Patent Application Publication
(10) Pub. No.: US 2015/0116117 A1
(43) Pub. Date: Apr. 30, 2015

(54) SYSTEM AND METHOD FOR PROVIDING SLEEP RECOMMENDATIONS

(71) Applicant: JAYBIRD LLC, Salt Lake City, UT (US)

(72) Inventors: BEN WISBEY, Canberra (AU); DAVID SHEPHERD, Canberra (AT); HAGEN DIESTERBECK, Little Bay (NZ)

(73) Assignee: JAYBIRD LLC, Salt Lake City, UT (US)

(21) Appl. No.: 14/147,384

(22) Filed: Jan. 3, 2014

Related U.S. Application Data
(63) Continuation-in-part of application No. 14/137,942, filed on Dec. 20, 2013.
Application No. 14/137,942 is a continuation-in-part of application No. 14/137,734, filed on Dec. 20, 2013.
Application No. 14/137,734 is a continuation-in-part of application No. 14/062,815, filed on Oct. 24, 2013.

(51) Int. Cl. G08B 21/24

(52) U.S. Cl. CPC G08B 21/24
USPC 340/575

(57) ABSTRACT

A system for providing a sleep recommendation includes an apparatus for providing a sleep recommendation. The apparatus includes a preferred sleep determination module that determines a preferred sleep duration. The apparatus also includes a sleep debt module that creates and updates a sleep debt based on the preferred sleep duration and an actual sleep duration. In addition, the apparatus includes a sleep recommendation module that provides a recommended sleep duration based on the sleep debt.

### CROSS REFERENCE TO RELATED APPLICATIONS

This application is a continuation-in-part of and claims the benefit of U.S. patent application Ser. No. 14/137,942, filed Dec. 20, 2013, titled “System and Method for Providing an Interpreted Recovery Score,” which is a continuation-in-part of U.S. patent application Ser. No. 14/137,734, filed Dec. 20, 2013, titled “System and Method for Providing a Smart Activity Score,” which is a continuation-in-part of U.S. patent application Ser. No. 14/062,815, filed Oct. 24, 2013, titled “Wristband with Removable Activity Monitoring Device.” The contents of the Ser. No. 14/137,942 application, the Ser. No. 14/137,734 application, and the Ser. No. 14/062,815 application are incorporated herein by reference.

### TECHNICAL FIELD

The present disclosure relates generally to sleep monitoring devices, and more particularly to a system and method for providing sleep recommendations.

### DESCRIPTION OF THE RELATED ART

Previous generation activity and sleep monitoring devices generally enabled only a tracking of sleep that provided an estimated sleep duration. Currently available sleep monitoring devices now add functionality that measures various parameters that may affect sleep quality. One issue is that currently available sleep monitoring devices do not learn a user's preferred sleep durations and provide sleep recommendations based on the preferred sleep durations. Another issue is that currently available solutions do not track a user's sleep debt and provide a notification that aids the user in remedying the user's sleep debt.

### BRIEF SUMMARY OF THE DISCLOSURE

In view of the above drawbacks, there exists a long-felt need for sleep monitoring devices that learn a user's preferred sleep durations and provide sleep recommendations based on the user's preferred sleep durations. Further, there is a need for sleep monitoring devices that track a user's sleep debt and provide notifications that aid the user in reducing the sleep debt and in getting to bed at a preferred bed time of the user.

Embodiments of the present disclosure include systems and methods for providing sleep recommendations.

One embodiment involves an apparatus for providing a sleep recommendation. The apparatus includes a preferred sleep determination module that determines a preferred sleep duration. The apparatus also includes a sleep debt module that creates and updates a sleep debt based on the preferred sleep duration and an actual sleep duration. In addition, the apparatus includes a sleep recommendation module that provides a recommended sleep duration based on the sleep debt.

The preferred sleep duration, in one embodiment, is based on a set of best sleep durations for a user. In a further embodiment, the set of best sleep durations is based on a set of the actual sleep durations. In one case, the apparatus includes an actual sleep determination module that determines the actual sleep duration using an accelerometer. The preferred sleep duration, in one embodiment, is based on a needed sleep duration provided by a user.

The apparatus, in another embodiment, includes a sleep reminder module that provides a sleep reminder based on the sleep debt. In one embodiment, the sleep reminder module provides the sleep reminder when the sleep debt exceeds a sleep debt threshold. The sleep reminder, in one case, includes a notification delivered to an electronic device. In one embodiment, the sleep reminder module provides the sleep reminder before a preferred bed time. In various embodiments, at least one of the preferred sleep determination module, the sleep debt module, and the sleep recommendation module is embodied in a wearable sensor.

One embodiment of the present disclosure involves a method for providing a sleep recommendation. The method includes determining a preferred sleep duration. The method also includes creating and updating a sleep debt based on the preferred sleep duration and an actual sleep duration. In addition, the method includes providing a recommended sleep duration based on the sleep debt.

The preferred sleep duration, in one embodiment, is based on a set of best sleep durations for a user. In a further embodiment, the set of best sleep durations is based on a set of actual sleep durations. The actual sleep durations, in one instance, are determined using an accelerometer.

In one case, the method includes providing a sleep reminder based on the sleep debt. Providing the sleep reminder, in one embodiment, occurs in response to the sleep debt exceeding a sleep debt threshold. In one case, the sleep reminder includes a notification delivered to an electronic device. Providing the sleep reminder, in one embodiment, occurs before a preferred bed time. In various embodiments, at least one of the operations of determining the preferred sleep duration, creating and updating the sleep debt, and providing the recommended sleep duration includes using a sensor configured to be attached to the body of the user.

One embodiment of the disclosure includes a system for providing a sleep recommendation. The system includes a processor and at least one computer program residing on the processor. The computer program is stored on a non-transitory computer readable medium having computer executable program code embodied thereon. The computer executable program code is configured to determine a preferred sleep duration. The computer executable program code is also configured to create and update a sleep debt based on the preferred sleep duration and an actual sleep duration. In addition, the computer executable program code is configured to provide a recommended sleep duration based on the sleep debt.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates a cross-sectional view of a wristband and electronic modules of an example sleep monitoring device.

FIG. 2 illustrates a perspective view of an example sleep monitoring device.

FIG. 3 illustrates a cross-sectional view of an example assembled sleep monitoring device.

FIG. 4 illustrates a side view of an example electronic capsule.

FIG. 5 illustrates a cross-sectional view of an example electronic capsule.

FIG. 6 illustrates perspective views of wristbands as used in one embodiment of the disclosed sleep monitoring device.

FIG. 7 illustrates an example system for providing a sleep recommendation.

FIG. 8 illustrates an example apparatus for providing a sleep recommendation.

FIG. 9 illustrates another example apparatus for providing a sleep recommendation.

FIG. 10 is an operational flow diagram illustrating an example method for providing a sleep recommendation.

FIG. 11 is an operational flow diagram illustrating an example method for providing a sleep recommendation including providing a sleep reminder.

FIG. 12 illustrates an example computing module that may be used to implement various features of the systems and methods disclosed herein.

The figures are not intended to be exhaustive or to limit the disclosure to the precise form disclosed. It should be understood that the disclosure can be practiced with modification and alteration, and that the disclosure can be limited only by the claims and the equivalents thereof.

### DETAILED DESCRIPTION

The present disclosure is directed toward systems and methods for providing sleep recommendations. The disclosure is directed toward various embodiments of such systems and methods. In one such embodiment, the systems and methods are directed to a device that provides a sleep recommendation. According to some embodiments of the disclosure, the device may be an electronic capsule embedded in and removable from an attachable device that may be attached to a user. In one embodiment, the attachable device is a wristband. In another embodiment, the attachable device includes a sleep and activity monitoring device.

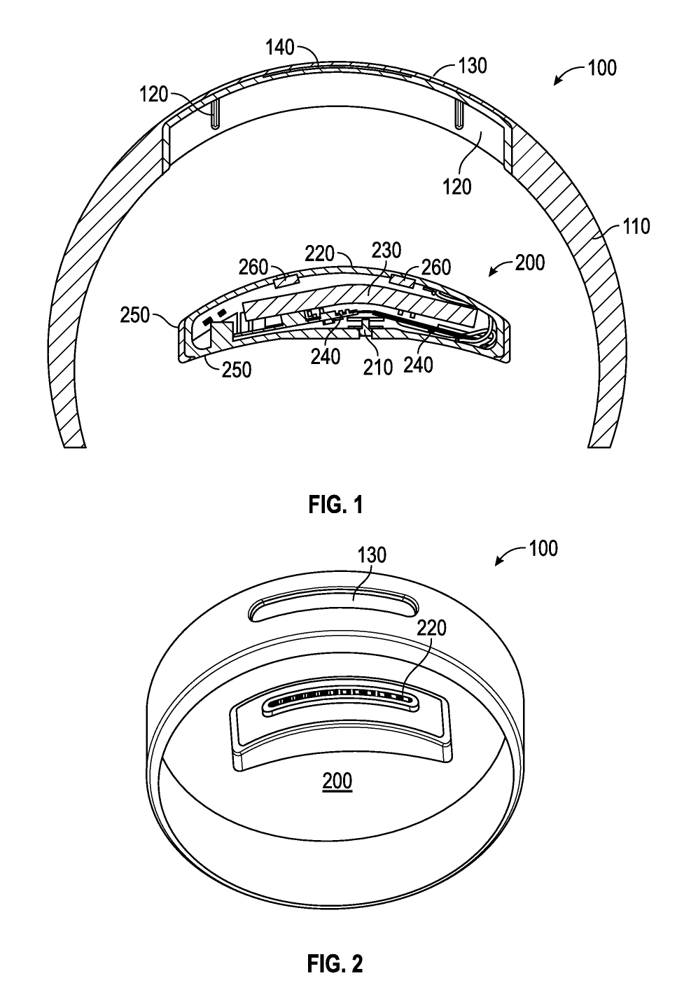

FIG. 1 is a diagram illustrating a cross-sectional view of an example embodiment of a sleep monitoring device. Referring now to FIG. 1, a sleep monitoring device includes electronic capsule 200 and wristband 100. Electronic capsule 200 includes wrist biosensor 210, finger biosensor 220, battery 230, one or more logic circuits 240, and casing 250.

In some embodiments, logic circuits 240 include an accelerometer, a wireless transmitter, a wireless receiver, and circuitry. Logic circuits 240 may further include a gyroscope. Logic circuits 240 may be configured to process electronic input signals from biosensors 210, 220 and the accelerometer, store the processed signals as data, and output the data using the wireless transmitter. The transmitter is configured to communicate using available wireless communications standards (e.g., over communication medium 704). For example, in some embodiments, the wireless transmitter is a BLUETOOTH transmitter, a Wi-Fi transmitter, a GPS transmitter, a cellular transmitter, or a combination thereof. In an alternative embodiment, the wireless transmitter further includes a wired interface (e.g. USB, fiber optic, HDMI, etc.) for communicating stored data.

Logic circuits 240 are electrically coupled to wrist biosensor 210 and finger biosensor 220. In addition, logic circuits 240 are configured to receive and process a plurality of electric signals from each of wrist biosensor 210 and finger biosensor 220. In some embodiments, the plurality of electric signals includes an activation time signal and a recovery time signal such that logic circuits 240 process the plurality of signals to calculate an activation recovery interval equal to the difference between the activation time signal and the recovery time signal. In some embodiments, the plurality of signals includes electro-cardio signals from a heart, and logic circuits 240 process the electro-cardio signals to calculate and store a RR-interval, and the RR-interval is used to calculate and store a heart rate variability (HRV) value. In such embodiments, the RR-interval is equal to the delta in time between two R-waves, where the R-waves are the electro-cardio signals generated by a ventricle contraction in the heart.

In some embodiments, logic circuits 240 further detect and store metrics such as the amount of physical activity, duration and quality of sleep or rest over a recent period of time, and the amount of time without physical activity over a recent period of time. Logic circuits 240 may then use the HRV, or the HRV in combination with these metrics, to calculate a fatigue level. For example, logic circuits 240 may detect the amount of physical activity and the amount of sleep a user experienced over the last 48 hours, combine those metrics with the user's HRV, and calculate a fatigue level of between 1 and 10. In such an example, the fatigue level may indicate the user's physical condition and aptitude for further physical activity that day. The fatigue level may also be represented on a descriptive scale—or example, low, normal, and high.

Finger biosensor 220 and wrist biosensor 210, in some embodiments, are replaced or supplemented by a single biosensor. In one such embodiment, the single biosensor is an optical biosensor, such as a pulse oximeter, configured to detect blood oxygen saturation levels. The pulse oximeter may output a signal to logic circuits 240 indicating a detected cardiac cycle phase, and logic circuits 240 may use cardiac cycle phase data to calculate an HRV value.

Wristband 100 includes material 110 configured to encircle a human wrist. In one embodiment, wristband 100 is adjustable. Cavity 120 is notched on the radially inward facing side of wristband 100 and is shaped to substantially the same dimensions as the profile of electronic capsule 200. In addition, aperture 130 is located in material 110 within cavity 120. Aperture 130 is shaped to substantially the same dimensions as the profile of finger biosensor 220. The combination of cavity 120 and aperture 130 is designed to detachably couple to electronic capsule 200 such that, when electronic capsule 200 is positioned inside cavity 120, finger biosensor 220 protrudes through aperture 130. Electronic capsule 200 may further include one or more magnets 260 configured to secure electronic capsule 200 to cavity 120. Magnets 260 may be concealed in casing 250. Cavity 120 may be configured to conceal magnets 260 when electronic capsule 200 detachably couples to the combination of cavity 120 and aperture 130.

Wristband 100 may further include steel strip 140 concealed in material 110, within cavity 120. In this embodiment, when electronic capsule 200 is positioned within cavity 120, one or more magnets 260 are attracted to steel strip 140 and pull electronic capsule 200 radially outward with respect to wristband 100. The force provided by magnets 260 may detachably secure electronic capsule 200 inside cavity 120. In further embodiments, electronic capsule 200 is positioned inside cavity 120 and affixed using a form-fit, press-fit, snap-fit, friction-fit, VELCRO, or other temporary adhesion or attachment technology.

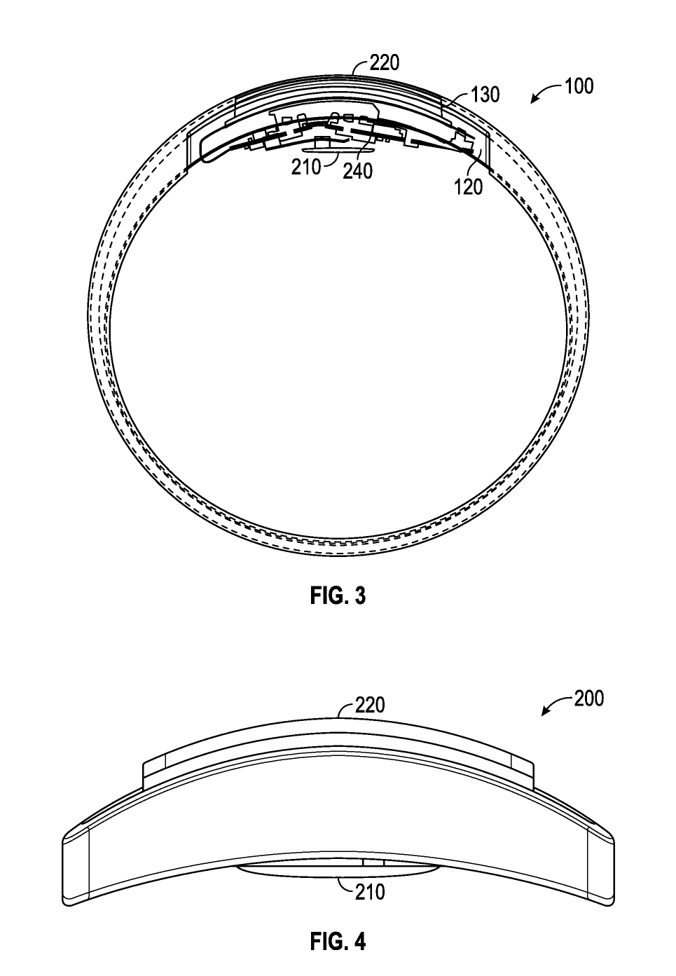

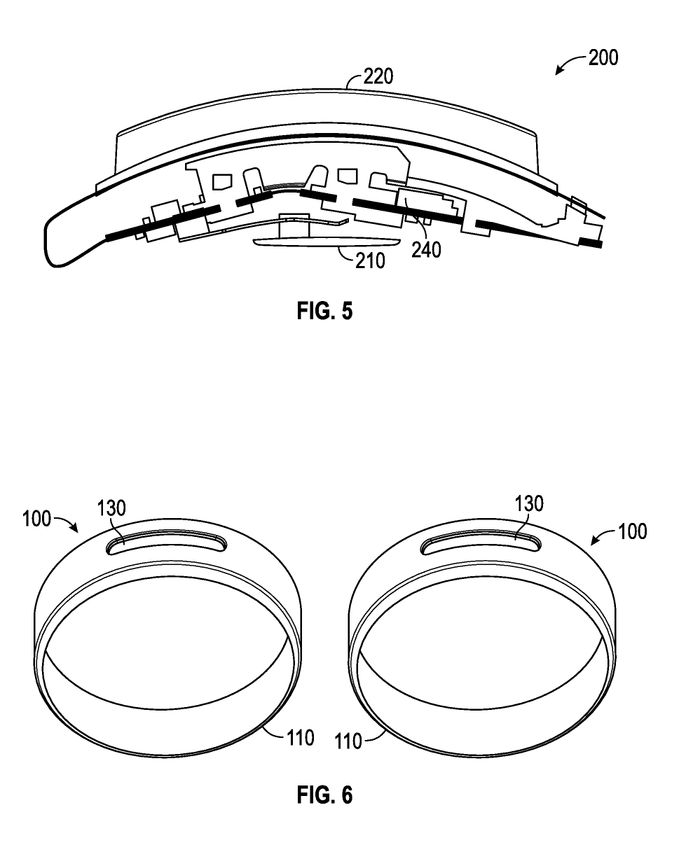

FIG. 2 illustrates a perspective view of one embodiment of the disclosed sleep monitoring device, in which wristband 100 and electronic capsule 200 are unassembled. FIG. 3 illustrates a cross-sectional view of one embodiment of a fully assembled wristband 100 with removable sleep monitoring device. FIG. 4 illustrates a side view of electronic capsule 200 according to one embodiment of the disclosure. FIG. 5 illustrates a cross-sectional view of electronic capsule 200. FIG. 6 is a perspective view of two possible variants of wristband 100 according to some embodiments of the disclosure. Wristbands 100 may be constructed with different dimensions, including different diameters, widths, and thicknesses, in order to accommodate different human wrist sizes and different preferences. Moreover, wristband 100 may be constructed to be streamlined to the user's wrist, such that wristband 100 is comfortable to wear during sleep.

In one embodiment of the disclosure, electronic capsule 200 includes an optical sensor, such as a heart rate sensor or oximeter. In this embodiment, the optical sensor is positioned to face radially inward toward a human wrist when wristband 100 is fit on the wrist. The optical sensor, in another example, is separate from electronic capsule 200, but is still detachably coupled to wristband 100 and electronically coupled to the circuit boards enclosed in electronic capsule 200. Wristband 100 and electronic capsule 200 may operate in conjunction with a system for providing a sleep recommendation.

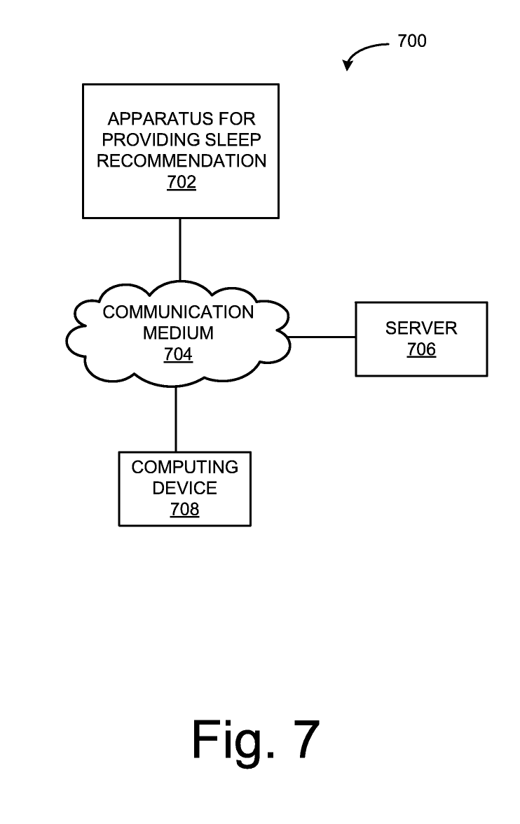

FIG. 7 is a schematic block diagram illustrating example system 700 for providing a sleep recommendation. System 700 includes apparatus for providing a sleep recommendation 702, communication medium 704, server 706, and computing device 708.

Communication medium 704 may be implemented in a variety of forms. For example, communication medium 704 may be an Internet connection, such as a local area network (“LAN”), a wide area network (“WAN”), a fiber optic network, internet over power lines, a hard-wired connection (e.g., a bus), and the like, or any other kind of network connection or series of network connections. Communication medium 704 may be implemented using any combination of routers, cables, modems, switches, fiber optics, wires, radio, and the like. Communication medium 704 may be implemented using various wireless standards, such as Bluetooth, Wi-Fi, 4G LTE, etc. One of skill in the art will recognize other ways to implement communication medium 704 for communications purposes.

Server 706 directs communications made over communication medium 704. Server 706 may be, for example, an Internet server, a router, a desktop or laptop computer, a smartphone, a tablet, a processor, a module, or the like. In one embodiment, server 706 directs communications between communication medium 704 and computing device 708. For example, server 706 may update information stored on computing device 708, or server 706 may send information to computing device 708 in real time.

Computing device 708 may take a variety of forms, such as a desktop or laptop computer, a smartphone, a tablet, a processor, a module, or the like. In addition, computing device 708 may be a processor or module embedded in a wearable sensor, a bracelet, a smart-watch, a piece of clothing, an accessory, and so on. For example, computing device 708 may be substantially similar to devices embedded in electronic capsule 200, which may be embedded in and removable from wristband 100, as illustrated in FIG. 1. Computing device 708 may communicate with other devices over communication medium 704 with or without the use of server 706. In one embodiment, computing device 708 includes apparatus 702. In various embodiments, apparatus 702 may be used to perform various processes described herein.

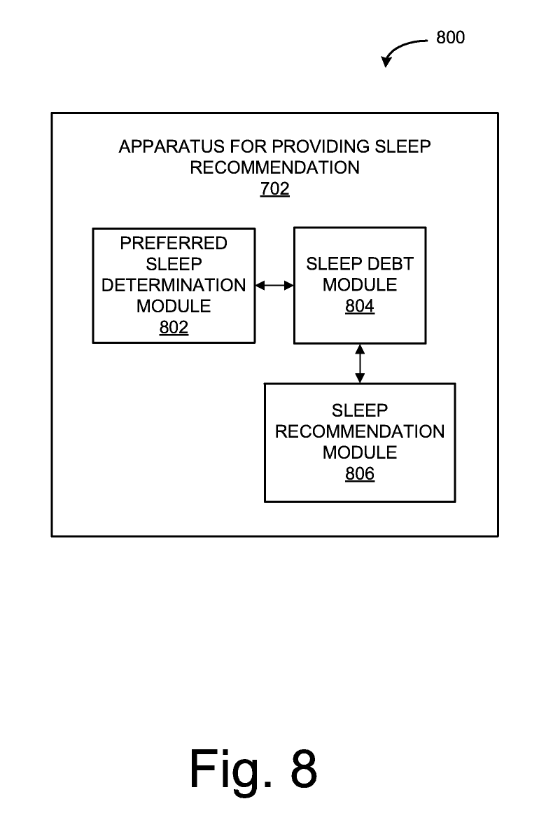

FIG. 8 is a schematic block diagram illustrating one embodiment of apparatus for providing a sleep recommendation 800. Apparatus 800 includes apparatus 702 with preferred sleep determination module 802, sleep debt module 804, and sleep recommendation module 806.

Preferred sleep determination module 802 determines a preferred sleep duration. Preferred sleep determination module 802 will be described below in further detail with regard to various processes.

Sleep debt module 804 creates and updates a sleep debt based on the preferred sleep duration and an actual sleep duration. Sleep debt module 804 will be described below in further detail with regard to various processes.

Sleep recommendation module 806 provides a recommended sleep duration based on the sleep debt. Sleep recommendation module 806 will be described below in further detail with regard to various processes.

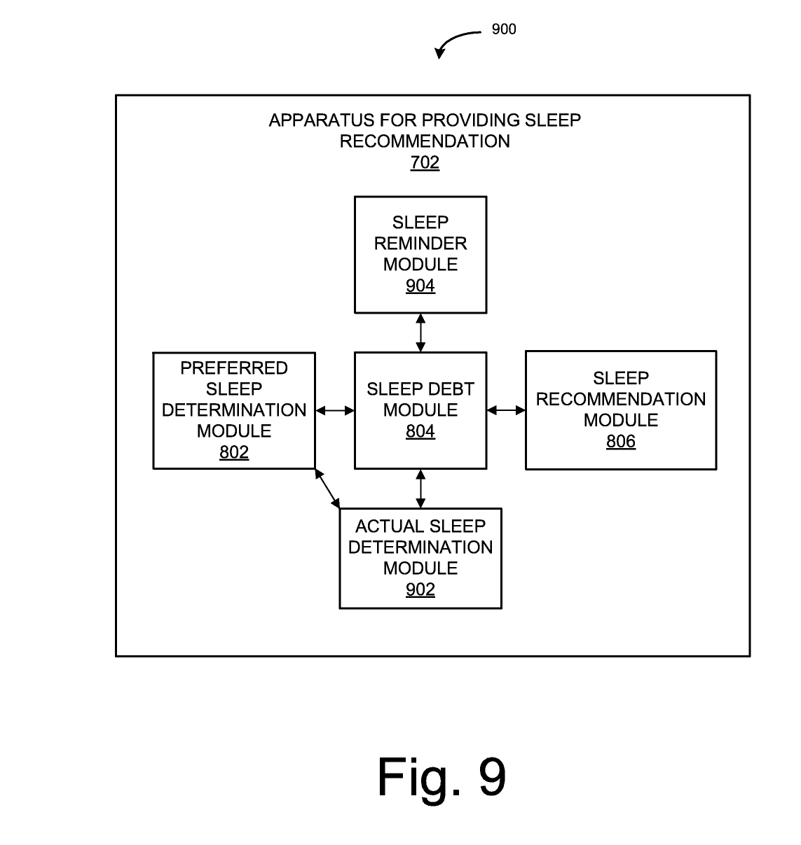

FIG. 9 is a schematic block diagram illustrating one embodiment of apparatus for providing a sleep recommendation 900. Apparatus 900 includes apparatus 702 with preferred sleep determination module 802, sleep debt module 804, and sleep recommendation module 806. Apparatus 900 also includes actual sleep determination module 902 that determines the actual sleep duration using an accelerometer. In addition, apparatus 900 includes sleep reminder module 904 that provides a sleep reminder based on the sleep debt. Actual sleep determination module 902 and sleep reminder module 904 will be described below in further detail with regard to various processes.

In one embodiment, at least one of preferred sleep determination module 802, sleep debt module 804, sleep recommendation module 806, actual sleep determination module 902, and sleep reminder module 904 is embodied in a wearable sensor, such as electronic capsule 200. In various embodiments, any of the modules described herein are embodied in electronic capsule 200 and connect to other modules described herein via communication medium 704.

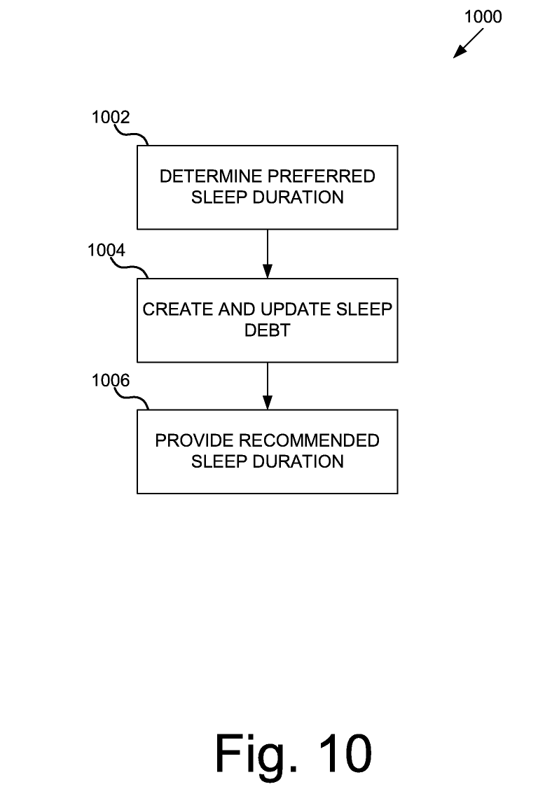

FIG. 10 is an operational flow diagram illustrating example method 1000 for providing a sleep recommendation in accordance with an embodiment of the present disclosure. The operations of method 1000 provide a sleep recommendation that is tuned specifically to a user's measured preferred sleep durations, as well as to the user's sleep debt. This aids in providing sleep recommendations that are specifically tailored to the user and that help the user eliminate sleep debt and get back on track with the user's preferred sleep patterns. In one embodiment, apparatus 702, wristband 100, and electronic capsule 200 perform various operations of method 1000.

At operation 1002, method 1000 involves determining a preferred sleep duration. The preferred sleep duration, in one embodiment, includes an amount of time, measured in hours and minutes, etc. In one embodiment of method 1000, an estimated preferred sleep duration—or needed sleep duration—is provided by a user as an initial matter. The user may enter the user's estimated preferred sleep duration via a user interface. As users typically are not able to provide accurate predictions for the estimated preferred sleep duration, the estimated preferred sleep duration may serve as a rough baseline in determining the user's preferred sleep duration.

In one embodiment, as more sleep data is gathered—i.e., as the user's actual sleep durations are measured—the estimated preferred sleep duration is phased out and replaced by an empirical preferred sleep duration. Whereas the estimated preferred sleep duration is based on an estimate provided by the user, the empirical preferred sleep duration is based on measured actual sleep duration. The actual sleep duration, in one embodiment, is determined using an accelerometer. In a further, embodiment, the actual sleep determination is further determined based on input from the user. For example, the user may indicate that the user is going to bed, at which point the accelerometer may begin to detect whether or not the user is asleep. The preferred sleep duration, in one illustrative example, includes a weighted combination of the estimated preferred sleep duration and the empirical preferred sleep duration. As more data is gathered, the empirical preferred sleep duration may be weighted more heavily and the estimated preferred sleep duration weighted less heavily.

For example, when the user initially provides the estimated preferred sleep duration, the estimated preferred sleep duration may be weighted to 100%. If the estimated preferred sleep duration is 8.0 hours, then the preferred sleep duration may be determined to be 8.0 hours. Then, after one week of measuring the user's actual sleep durations, the empirical preferred sleep duration may be 7.0 hours. If, for example, the weighting after one week were 50/50, the preferred sleep duration may be determined to be 7.5 hours.

After gathering a substantial amount of actual sleep data, the empirical preferred sleep duration may likely be more reliable than the estimated preferred sleep duration, and thus may eventually be weighted 100%, with the estimated preferred sleep duration weighted 0%. In other words, in this embodiment, the empirical preferred sleep duration gradually phases out the estimated sleep duration as the user's true (measured) preferred sleep duration is learned. The rate at which the empirical preferred sleep duration phases out the estimated sleep duration may depend on various factors. For example, the rate my depend on the difference between the empirical preferred sleep duration and the estimated sleep duration, the rate of change of the preferred sleep duration, and the like.

The preferred sleep duration, in one embodiment, is substantially based on the empirical preferred sleep duration. In one instance, the empirical preferred sleep duration is based on a set of best sleep durations for the user. The set of best sleep durations, in one embodiment, is based on a set of the actual sleep durations. The best sleep durations, by way of example, may include a set of the user's longest actual sleep durations (i.e., the best sleep duration may be a subset of the actual sleep durations). In such an example, the preferred sleep duration may be the mean of the user's best sleep durations. To illustrate, if thirty actual sleep durations have been measured, the best sleep durations may include the top two-thirds longest actual sleep durations. In such an example, the preferred sleep duration would be averaged only from those top two-thirds longest actual sleep durations (i.e., the best sleep durations), and the bottom one thirds, representing the shortest actual sleep durations, would not factor in to the preferred sleep duration.

In one embodiment, method 1000 involves detecting causes of the user's best sleep (or best sleep causes). For example, the user might achieve the user's best sleep when the user exercises in the morning, or when the user refrains from drinking Diet Coke®. In such examples, these causes for the best sleep are detected and presented to the user. This may aid the user in attaining the user's best sleep and in eliminating sleep debt. The best sleep causes, in one embodiment, are detected automatically by detecting patterns of activities that precede the user's best sleep durations. By way of example, method 1000 may detect that in 90% of the user's best sleep durations, the user exercised in the morning before the best sleep duration. In another embodiment, the user is prompted following the best sleep duration as to what the user thinks was the cause of the best sleep. This may be done through a user interface.

After detecting the best sleep causes, in one embodiment, the user is provided with suggestions to aid in achieving the best sleep duration. Such suggestions may include the best sleep causes. For example, if morning exercise is detected as a best sleep cause for the user, the user may receive a suggestion that the user should exercise in the morning. The best sleep cause suggestions may be provided by a user interface, such as graphically, by message, and so on.

Referring again to FIG. 10, operation 1004 includes creating and updating a sleep debt based on the preferred sleep duration and the actual sleep duration. The sleep debt, in one embodiment, is created based on the difference between the preferred sleep duration and the actual sleep duration. Similarly, the sleep debt, in such an embodiment, is updated after each night based on the difference between the preferred sleep duration and the actual sleep duration. The sleep debt may be compared to a sleep debt threshold to determine whether the sleep debt is greater than, less than, or equal to the sleep debt threshold. In one embodiment, the best sleep cause suggestions are provided when the sleep debt exceeds the sleep debt threshold. For example, if the sleep debt threshold is two hours, and the sleep debt exceeds two hours, it may be suggested that the user exercise in the morning (if morning exercise has been determined to be a best sleep cause).

In one instance, the sleep debt is updated periodically. For example, the sleep debt may represent the average of the difference between the preferred sleep duration and the actual sleep duration over a period of ten days. To illustrate, the sleep debt may reflect that the user is, on average, twenty minutes behind per night over the last ten days. This would mean that, on average, the actual sleep duration measured was twenty minutes less than the preferred sleep duration. The sleep debt may also be negative, indicating that the actual sleep duration was greater than the preferred sleep duration.

Referring again to FIG. 10, operation 1006 involves providing a recommended sleep duration based on the sleep debt (determined at operation 1004). In one embodiment, the recommended sleep duration aids the user in eliminating the user's sleep debt. For example, if the user has a sleep debt of twenty minutes per night averaged over the last ten days, the recommended sleep duration may be that the user get forty minutes more than the user's preferred sleep over the next five days. This may help the user to approximate the user's preferred sleep duration in the long run and overcome the user's sleep debt. In one embodiment, the recommended sleep duration helps the user to gradually eliminate the user's sleep debt. This may be more beneficial than, for example, attempting to eliminate the sleep debt in a single or just a few nights.

In one embodiment, the recommended sleep duration is further based on a fatigue level. For example, a higher fatigue level may correspond to a longer recommended sleep duration, while a lower fatigue level may correspond to a shorter recommended sleep duration. The fatigue level may be detected in various ways. In one example, the fatigue level is detected by measuring a heart rate variability (HRV) of the user using logic circuits 240 (discussed above in reference to FIG. 1). Further, possible representations of the fatigue level are described above (e.g., numerical, descriptive, etc.). When the HRV is more consistent (i.e., steady, consistent amount of time between heartbeats), for example, the fatigue level may be higher. When HRV is more sporadic (i.e., amount of time between heartbeats varies largely), the fatigue level may be lower. In general, with a lower fatigue level, the body is more fresh and well-rested.

HRV may be measured in a number of ways (discussed above in reference to FIG. 1). Measuring HRV, in one embodiment, involves the combination of wrist biosensor 210 and finger biosensor 220. Wrist biosensor 210 may measure the heartbeat in the wrist of one arm while finger sensor 220 measures the heartbeat in a finger of the hand of the other arm. This combination allows the sensors, which in one embodiment are conductive, to measure an electrical potential through the body. Information about the electrical potential provides cardiac information (e.g., HRV, fatigue level, heart rate information, and so on), and such information may be processed. In other embodiments, the HRV is measured using sensors that monitor other parts of the user's body, rather than the finger and wrist. For example, the sensors may monitor the ankle, leg, arm, or torso.

The fatigue level, in another embodiment, factors into determining the preferred sleep duration. For example, if a higher fatigue level is detected after a shorter or longer amount of sleep, this may be useful data in determining the user's preferred sleep duration. The preferred sleep duration may be the sleep duration that minimizes the fatigue level detected following that sleep duration.

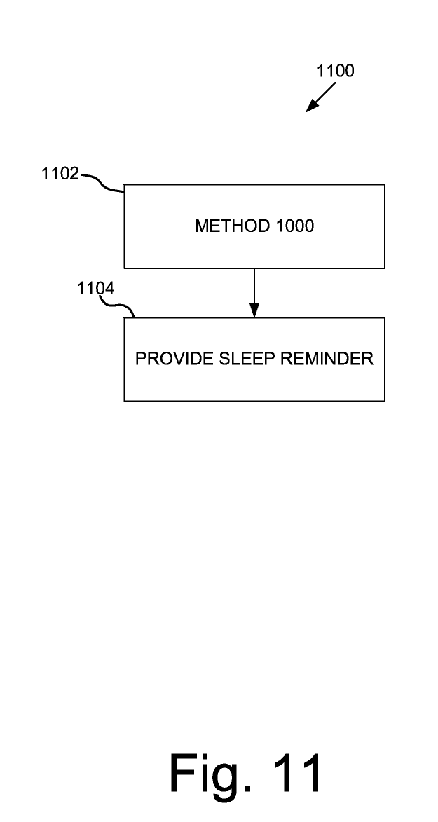

FIG. 11 is an operational flow diagram illustrating example method 1100 for providing a sleep recommendation. In one embodiment, apparatus 702, wristband 100, and electronic capsule 200 perform various operations of method 1100. Method 1100, in various embodiments, includes one or more operations of method 1000, represented at operation 1102.

In one embodiment, at operation 1104, method 1100 involves providing a sleep reminder based on the sleep debt. The sleep reminder, in one instance, is provided when the sleep debt exceeds a sleep debt threshold. For example, the sleep debt threshold may be two hours. If the sleep debt exceeds two hours, the sleep reminder may be provided to aid the user in eliminating the sleep debt. In one embodiment, the sleep reminder includes a notification delivered to an electronic device, which may include a smartphone, television, tablet, smartwatch, or other device. The notification may be in the form of a text message, a pop-up window, an alert, and so on.

Providing the sleep reminder, in one embodiment, occurs before a preferred bed time of the user. The preferred bed time, similar to the preferred sleep duration, may be based on a combination of user input of an estimated preferred bed time and an empirical preferred bed time based on the user's preferred sleep duration. The empirical preferred bed time, in one embodiment, is the bed time that corresponds to the user's preferred sleep durations. For example, the user may achieve the user's preferred sleep duration when the user goes to bed at a particular time, and the user may accrue significant sleep debt when the user goes to bed at another time (e.g., later at night). The preferred bed time, in one embodiment, updates dynamically in response to changes in the user's empirical preferred sleep durations.

In another embodiment, the user enters the preferred bed time and freezes the preferred bed time, such that the preferred bed time remains fixed, or static. Whether the preferred bed time is fixed or dynamic, the sleep reminder, in one embodiment, is provided before the preferred bed time. The sleep reminder may be provided thirty minutes before the preferred bed time, for example. In one embodiment, this amount of time is programmable by the user. Providing the sleep notification before the preferred bed time may allow the user to get ready for bed and go to sleep at the preferred bed time.

In a further embodiment, the bed time notification is adjusted based on the sleep debt such that the user may comply with the recommended sleep duration—that is, such that the user can get to bed early enough to achieve the recommended sleep duration and still wake up in time to fulfill the user's obligations in the morning. This further aids in eliminating sleep debt. In one case, the bed time notification is synced to one or more calendars, including the user's calendar. This allows for the bed time notification to adjust automatically in anticipation of the user's obligations in the morning and provide the user ample time to eliminate the user's sleep debt.

In various embodiments, at least one of the operations of determining the preferred sleep duration, creating and updating the sleep debt, providing the recommended sleep duration, and providing the sleep reminder includes using a sensor configured to be attached to the body of the user.

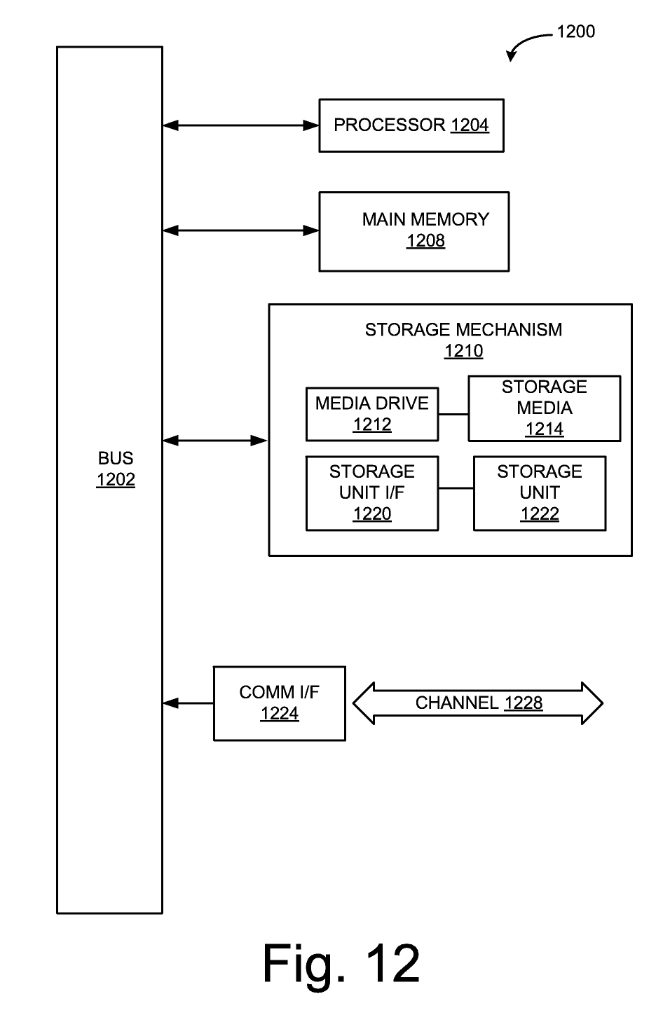

FIG. 12 illustrates an example computing module that may be used to implement various features of the systems and methods disclosed herein. In one embodiment, the computing module includes a processor and a set of computer programs residing on the processor. The set of computer programs is stored on a non-transitory computer readable medium having computer executable program code embodied thereon. The computer executable code is configured to determine a preferred sleep duration. The computer executable code is further configured to create and update a sleep debt based on the preferred sleep duration and an actual sleep duration. In addition, the computer executable code is configured to provide a recommended sleep duration based on the sleep debt.

The example computing module may be used to implement these various features in a variety of ways, as described above with reference to the methods illustrated in FIGS. 10 and 11 and as will be appreciated by one of ordinary skill in the art.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example-computing module 1200. After reading this description, it will become apparent to a person skilled in the relevant art how to implement the application using other computing modules or architectures.

Referring now to FIG. 12, computing module 1200 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1200 might include, for example, one or more processors, controllers, control modules, or other processing devices, such as a processor 1204. Processor 1204 might be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally.

Computing module 1200 might also include one or more memory modules, simply referred to herein as main memory 1208. For example, preferably random access memory (RAM) or other dynamic memory, might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device coupled to bus 1202 for storing static information and instructions for processor 1204.

The computing module 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid state drive, a magnetic tape drive, an optical disk drive, a CD or DVD drive (R or RW), or other removable or fixed media drive might be provided. Accordingly, storage media 1214 might include, for example, a hard disk, a solid state drive, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing module 1200. Such instrumentalities might include, for example, a fixed or removable storage unit 1222 and a storage interface 1220. Examples of such storage units 1222 and storage interfaces 1220 can include a program cartridge and cartridge interface, a removable memory (for example, a flash memory or other removable memory module) and memory slot, a PCMCIA slot and card, and other fixed or removable storage units 1222 and storage interfaces 1220 that allow software and data to be transferred from the storage unit 1222 to computing module 1200.

Computing module 1200 might also include communications interface 1224. Communications interface 1224 might be used to allow software and data to be transferred between computing module 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable computing module 1200 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that these embodiments have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the present disclosure. Also, a multitude of different constituent module names other than those depicted herein can be applied to the various partitions. Additionally, with regard to flow diagrams, operational descriptions, and method claims, the order in which the steps are presented herein does not mandate that various embodiments be implemented to perform the recited functionality in the same order, unless the context dictates otherwise.

Although the disclosure is described above in terms of various exemplary embodiments and implementations, it should be understood that the various features, aspects, and functionalities described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. An apparatus for providing a sleep recommendation, comprising:
a preferred sleep determination module that determines a preferred sleep duration;
a sleep debt module that creates and updates a sleep debt based on the preferred sleep duration and an actual sleep duration; and
a sleep recommendation module that provides a recommended sleep duration based on the sleep debt.

2. The apparatus of claim 1, wherein the preferred sleep duration is based on a set of best sleep durations for a user.

3. The apparatus of claim 2, wherein the set of best sleep durations is based on a set of the actual sleep durations.

4. The apparatus of claim 1, further comprising a sleep reminder module that provides a sleep reminder based on the sleep debt.

5. The apparatus of claim 4, wherein the sleep reminder module provides the sleep reminder when the sleep debt exceeds a sleep debt threshold.

6. The apparatus of claim 4, wherein the sleep reminder comprises a notification delivered to an electronic device.

7. The apparatus of claim 4, wherein the sleep reminder module provides the sleep reminder before a preferred bed time.

8. The apparatus of claim 1, wherein the preferred sleep duration is based on a needed sleep duration provided by a user.

9. The apparatus of claim 1, further comprising an actual sleep determination module that determines the actual sleep duration using an accelerometer.

10. The apparatus of claim 1, wherein at least one of the preferred sleep determination module, the sleep debt module, and the sleep recommendation module is embodied in a wearable sensor.

11. A method for providing a sleep recommendation, comprising:
determining a preferred sleep duration;
creating and updating a sleep debt based on the preferred sleep duration and an actual sleep duration; and
providing a recommended sleep duration based on the sleep debt.

12. The method of claim 11, wherein the preferred sleep duration is based on a set of best sleep durations for a user.

13. The method of claim 12, wherein the set of best sleep durations is based on a set of the actual sleep determinations.

14. The method of claim 11, further comprising providing a sleep reminder based on the sleep debt.

15. The method of claim 14, wherein providing the sleep reminder occurs in response to the sleep debt exceeding a sleep debt threshold.

16. The method of claim 14, wherein the sleep reminder comprises a notification delivered to an electronic device.

17. The method of claim 14, wherein providing the sleep reminder occurs before a preferred bed time.

18. The method of claim 11, wherein the actual sleep duration is determined using an accelerometer.

19. The method of claim 11, wherein at least one of the operations of determining the preferred sleep duration, creating and updating the sleep debt, and providing the recommended sleep duration comprises using a sensor configured to be attached to the body of a user.

20. A system for providing a sleep recommendation, comprising:
a processor; and
at least one computer program residing on the processor;
wherein the computer program is stored on a non-transitory computer readable medium having computer executable program code embodied thereon, the computer executable program code configured to:
determine a preferred sleep duration;
create and update a sleep debt based on the preferred sleep duration and an actual sleep duration; and
provide a recommended sleep duration based on the sleep debt.
